(19) United States
(12) Patent Application Publication
(10) Pub. No.: US 2026/0127280 A1
(43) Pub. Date: May 7, 2026

(54) USING FEATURE VECTOR WINDOWS TO INFER AND MITIGATE RANSOMWARE ACTIVITY

(71) Applicant: International Business Machines Corporation, Armonk, NY (US)

(72) Inventors: Roman Alexander Pletka, Uster (CH); Dionysios Diamantopoulos, Zurich (CH); Nicolás Hernán Reátegui Rodriguez, Kilchberg (CH); Charalampos Pozidis, Thalwil (CH); Yves Alexandre Beraldo Dos Santos, Marana, AZ (US); Andrew D. Walls, San Jose, CA (US)

(21) Appl. No.: 18/936,766

(22) Filed: Nov. 4, 2024

(51) Int. Cl. G06F 21/56; G06N 5/04

(52) U.S. Cl. CPC G06F 21/56; G06N 5/04; G06F 2221/034

(57) ABSTRACT

A method, according to one embodiment, includes adding an incoming first feature vector to an outer window. In response to a determination that the first feature vector is a qualifying feature vector, the first feature vector is added into a voting window. In response to a determination that the outer window is full, a relatively oldest feature vector is removed from the outer window. The method further includes using feature vectors in the voting window to infer ransomware activity. A computer program product, according to another embodiment, includes one or more computer-readable storage media, and program instructions stored on the one or more storage media to perform the foregoing method. A computer system, according to another embodiment, includes a processor set, one or more computer-readable storage media, and program instructions stored on the one or more storage media to cause the processor set to perform the foregoing method.

### BACKGROUND

The present invention relates to storage systems, and more specifically, this invention relates to ransomware detection in storage systems.

Ransomware is a type of malware that holds a victim's sensitive data and/or device hostage, threatening to keep the sensitive data and/or device locked and/or exploited (e.g., leaked online to the public) unless the victim pays a ransom to the attacker. The earliest ransomware attacks simply demanded a ransom in exchange for the encryption key needed to regain access to the affected data or use of the infected device. However, these attacks have evolved to include double-extortion and triple-extortion tactics that expand the threat of a ransomware attack beyond the aforementioned victim to customers, family, friends, business partners, etc. Even victims who rigorously maintain data backups of a storage system or pay the initial ransom demand are at risk of ransomware attacks.

### SUMMARY

A method, according to one embodiment, includes adding an incoming first feature vector to an outer window. In response to a determination that the first feature vector is a qualifying feature vector, the first feature vector is added into a voting window. In response to a determination that the outer window is full, a relatively oldest feature vector is removed from the outer window. The method further includes using feature vectors in the voting window to infer ransomware activity.

A computer program product, according to another embodiment, includes one or more computer-readable storage media, and program instructions stored on the one or more storage media to perform the foregoing method.

A computer system, according to another embodiment, includes a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 depicts a storage system infrastructure, in accordance with one embodiment of the present invention.

FIG. 4 is a flowchart of a method, in accordance with one embodiment of the present invention.

FIGS. 5A-5B depict plots of the I/O behavior of various ransomware samples, in accordance with several embodiments of the present invention.

FIGS. 6A-6C depict a time progression, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using feature vector windows to infer and mitigate ransomware activity.

In one general embodiment, a method includes adding an incoming first feature vector to an outer window. In response to a determination that the first feature vector is a qualifying feature vector, the first feature vector is added into a voting window. In response to a determination that the outer window is full, a relatively oldest feature vector is removed from the outer window. The method further includes using feature vectors in the voting window to infer ransomware activity.

In another general embodiment, a computer program product includes one or more computer-readable storage media, and program instructions stored on the one or more storage media to perform the foregoing method.

In another general embodiment, a computer system includes a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as feature vector window management code of block 150 for using feature vector windows to infer and mitigate ransomware activity. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

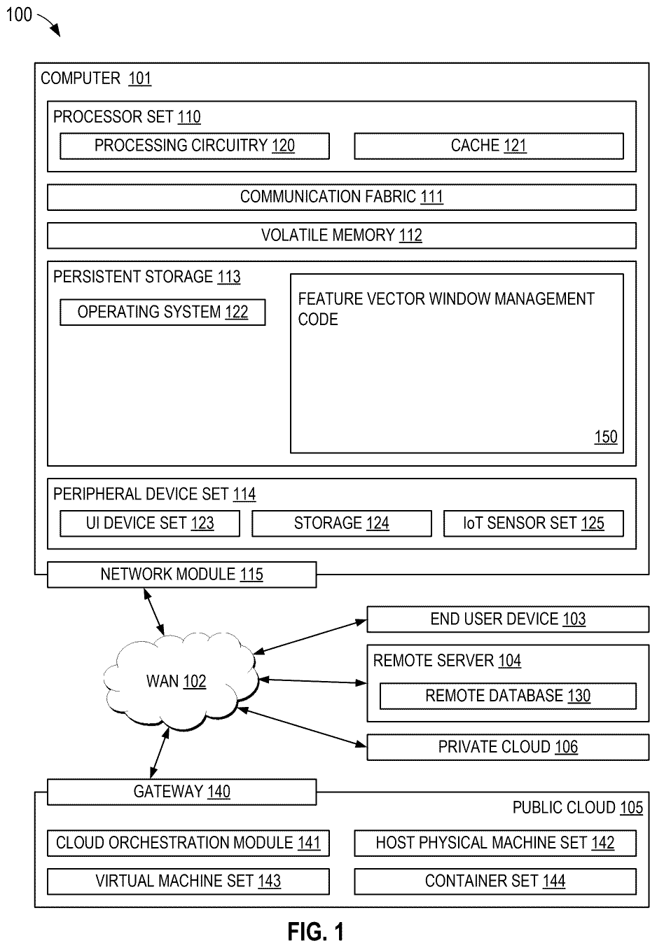

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, ransomware is a type of malware that holds a victim's sensitive data and/or device hostage, threatening to keep the sensitive data and/or device locked and/or exploited (e.g., leaked online to the public) unless the victim pays a ransom to the attacker. The earliest ransomware attacks simply demanded a ransom in exchange for the encryption key needed to regain access to the affected data or use of the infected device. However, these attacks have evolved to include double-extortion and triple-extortion tactics that expand the threat of a ransomware attack beyond the aforementioned victim to customers, family, friends, business partners, etc. Even victims who rigorously maintain data backups of a storage system or pay the initial ransom demand are at risk of ransomware attacks.

Ransomware attacks are associated with compromised performance of computer device within the technical field of storage systems. This is because ransomware attacks are specifically designed to disrupt intended and normal operations of these computer devices in order to extort rewards from victims of the ransomware attacks. This compromised performance occurs for at least the period that the ransomware attack disrupts processing operations of the computer device. These disrupted processing operations also contribute to compromised performance of a storage system that the computer device operates within. Accordingly, there is a longstanding and unmet need for solutions to efficiently mitigate ransomware attacks within the technical field of data storage systems.

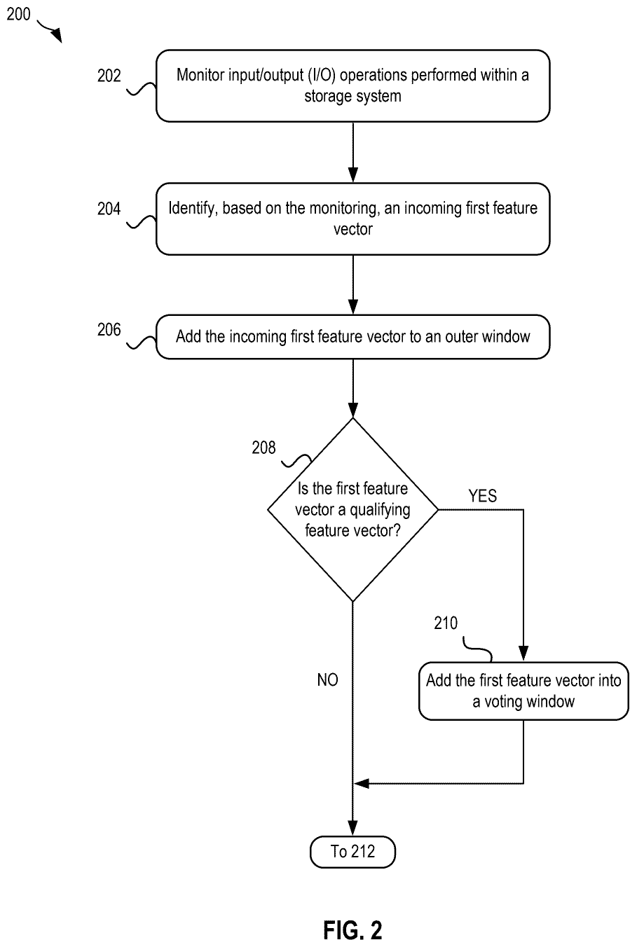

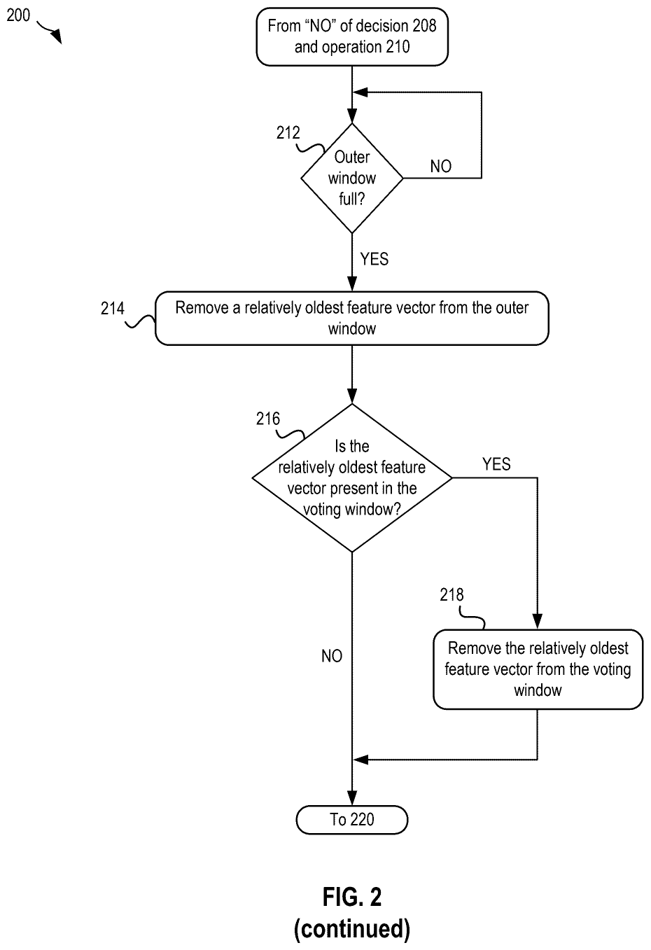

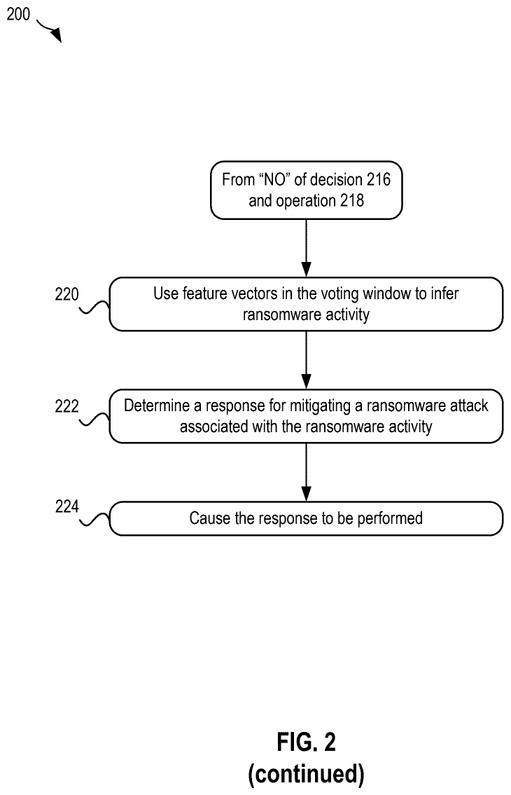

Now referring to FIG. 2, a flowchart of a method 200 is shown according to one embodiment. The method 200 may be performed in accordance with aspects of the present invention in any of the environments depicted in FIGS. 1-6C, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that various embodiments and approaches described herein are related to ransomware detection in block storage and may be utilized to process a time series of feature vectors for ransomware detection where the detection is performed on a set of feature vectors. In order to detect and prevent ransomware events, feature information is extracted from I/O operations. The extracted feature information is preferably used to train ML models but also to run inferencing operations using the trained model inside a storage system on host I/O operations. Features from I/O operations are preferably summarized in intervals of a few seconds (e.g., epoch) to generate feature vectors. To improve accuracy, an inference result is evaluated over a window of time in the order of several tens of seconds and schemes such as majority voting can be used to trigger ransomware alerts so that preventative operations may be performed in order to mitigate a ransomware threat. The techniques of some embodiments and approaches described herein note that in traces, even when ransomware is active, there are time periods in which no write activity occurs, or in other words time periods during which a ransomware activity is obviously not present in the observed IO operations. During these periods the ransomware may for example be interrupted by the operating systems or other applications, contacting a command-and-control server over the network, creating encryption keys, or performing other tasks that do not result in IO activity. In some cases, these periods with no writes and writes may be intermingled. These periods with no write activity are not considered to be malign (in the sense of ransomware making data inaccessible). However, simple re-labeling periods with no writes introduces potential drawbacks upon post-processing of the detection signal. Accordingly, the techniques of embodiments and approaches described herein maintain different windows of feature vectors (where the different windows are based on whether or not write operations have been performed when the feature vectors are extracted) in order to use the feature vectors to infer and prevent ransomware activity. While periods with no writes have been used in some approaches herein to describe periods during which a ransomware activity is not present it is clear that other indicators can be used as will be well understood by those skilled in the art. Non-qualifying feature vectors also denoted as feature vectors not presenting ransomware activity may be easily identified and not require a ML-based classifier. In particular, feature vectors not presenting ransomware activity may exhibit among others no write operations, a very low write rate, and/or only low entropy in all write IO operations and/or a combination thereof.

In order to enable ransomware detection and prevention in a data storage system (and/or a plurality of monitored systems), in some approaches, feature vector monitoring may be performed. Feature vector monitoring of a type that would become apparent to one of ordinary skill in the art after reading the descriptions herein may be used. The feature vectors may detail feature information about operations (such as read and/or write I/O operations) performed within a storage system. Accordingly, in some approaches, the feature information may be defined as any piece of information that is relevant for solving the computational task related to an application associated with the storage system. In some preferred approaches, the feature information includes, e.g., read transfer size, write transfer size, an entropy of writes (such as a Shannon's entropy of writes), an application tag (such as a Non-Volatile Memory Express (NVMe) application tag which may be a volume tag), a logical block address (LBA) of a write operation, and an LBA of a read operation, etc.

The monitoring described above may, in some approaches, include monitoring (e.g., sampling) I/O operations performed within a storage system, e.g., see operation 202. This sampling may be performed over a plurality of different time windows (windowing) in which aggregated features are extracted from I/O information using a moving window of time, e.g., over a predetermined number of seconds which may, in some preferred approaches, be included in a predetermined range of 1-10 seconds. During the monitoring, in response to a determination that an I/O operation has been initiated and/or performed, information associated therewith is processed as an “incoming” new feature vector.

For example, an incoming new first feature vector may be identified and be added to an outer window, e.g., see operation 204 and operation 206. The first feature vector details feature information about operations performed within the storage system. For context, the “outer window” described in various approaches herein may be defined as an aggregated collection of feature vectors, where the outer window has a predefined (and potentially dynamically adjustable) capacity of feature vectors, e.g., ten feature vectors, twenty feature vectors, one-hundred feature vectors, etc., and may include all feature vectors that have been identified during a current monitoring window, where the current monitoring window extends from the current time back to a previous predetermined number of feature vectors. In a first approach, an incoming feature vector described herein may be an aggregated feature vector that aggregates a plurality of feature vectors that detail I/O operations performed for the same storage volume (an aggregation of feature vectors per storage volume over one epoch). Simply put, in some approaches, the outer window records feature vectors from all epochs.

It should be noted that, in some approaches, the first feature vector is added to the outer window regardless of whether the first feature vector is a qualifying feature vector. For example, in some approaches, a qualifying feature vector may be a feature vector having write operations that are detected in a period covering the feature vector. Accordingly, in one or more of such approaches, a determination may be made as to whether the first feature vector is a qualifying feature vector (see decision 208), and more specifically, whether write operations are detected in a period covering the first feature vector. In contrast, addition of a feature vector to another window may, in some approaches, be dependent on whether write operations are detected in the period covering the first feature vector. In some approaches, timestamp information associated with the write operations may be compared with timestamp information associated with the first feature vector (where the first feature vector details information other than write information). In some other approaches, the determination of whether write operations are detected in a period covering the first feature vector may be based on whether write information is included in the information of the first feature vector.

In response to a determination that the first feature vector is a qualifying feature vector (as illustrated by the “YES” logical path of decision 208), the first feature vector is added into a voting window, e.g., see operation 210. In furtherance of the examples above in which the determination of whether the first feature vector is a qualifying feature vector is based on whether write operations are detected in the period covering the first feature vector, the first feature vector is determined to be a qualifying feature vector in response to a determination that write operations are detected in a period covering the first feature vector. For context, the “voting window” described in various approaches herein may be defined as an aggregated collection of some of the feature vectors of the outer window (a sub-portion of the feature vectors that are currently in the outer window). Accordingly, the voting window may be a fraction of the overall size of the outer window (the voting window may be an “inside window”). In some approaches, the outer window has a predefined (and potentially dynamically adjustable) capacity of feature vectors, e.g., two feature vectors, four feature vectors, ten feature vectors, etc., and may include a sub-portion of all the feature vectors that have been identified during the current monitoring window. Simply put, in some approaches, the voting window (also referred to herein as the inner window) only holds epochs with write activity.

In response to a determination that the first feature vector is not a qualifying feature vector (as illustrated by the “NO” logical path of decision 208), the first feature vector is preferably not added into the voting window and the method optionally continues to decision 212. In furtherance of the examples above in which the determination of whether the first feature vector is a qualifying feature vector is based on whether write operations are detected in the period covering the first feature vector, the first feature vector is determined to not be a qualifying feature vector in response to a determination that write operations are not detected in the period covering the first feature vector.

Because the windows are maintained to eventually be used to determine and prevent ransomware attacks (as will be described in greater detail elsewhere herein), the feature vectors that are included in the windows at any given time are preferably relevant feature vectors rather than outdated (stale) feature vectors. This way, a current state of a data storage system that the feature vectors are based on is maintained in the windows and used for ransomware analysis. In some approaches, in order to maintain the windows in such a way, relatively newer feature vectors are prioritized over relatively older feature vectors. For example, in some approaches, a determination is made as to whether the outer window is full, e.g., see decision 212. The determination of whether the outer window is full may be based on a predetermined threshold that caps the size of the outer window. This threshold may be dynamically decreased in order to reduce a processing load of a model that is analyzing the feature vectors of the windows and/or dynamically increased in order to increase an accuracy of the model that is analyzing the feature vectors of the windows.

In response to a determination that the outer window is not full (as illustrated by the “NO” logical path of decision 212) monitoring for whether the outer window optionally continues, and in some approaches, more incoming feature vectors may optionally be added to the outer window. In contrast, in some approaches, in response to a determination that the outer window is full (as illustrated by the “YES” logical path of decision 212), a relatively oldest feature vector is removed from the outer window, e.g., see operation 214. The relatively oldest feature vector includes a second feature vector that is different than the first feature vector. In some approaches, the relatively oldest feature vector may not be the feature vector that was added to the outer window least recently. However, the relatively oldest feature vector is preferably based on operations performed within the storage system relatively least recently.

Similar maintenance operations may additionally and/or alternatively be performed with respect to the voting window in order to ensure that the feature vectors of the voting window are relatively up to date and do not amount to a relatively extensive amount of information. For example, a determination may be made as to whether the relatively oldest feature vector is present in the voting window, e.g., see operation 216. In some approaches, any removal operations may be conditionally performed (a first feature vector is only remoted from the voting window in response to a determination that the first feature vector is also being remoted from the outer window). For example, in some approaches, in response to the determination that the outer window is full, the determination is made as to whether the relatively oldest feature vector is present in the voting window. In response to a determination that the relatively oldest feature vector is present in the voting window (as illustrated by the “YES” logical path of decision 216), the relatively oldest feature vector is removed from the voting window, e.g., see operation 218. In response to a determination that the relatively oldest feature vector is not present in the voting window (as illustrated by the “NO” logical path of decision 216), the method optionally continues to operation 220.

Operation 220 includes using feature vectors in the voting window to infer ransomware activity. In some approaches, the feature vectors in the outer window are not used to infer the ransomware activity, e.g., only the feature vectors in the voting window are used to infer ransomware activity. However, the feature vectors in the outer window may, in some approaches, be used for training an artificial intelligence (AI) model to cause the AI engine (AI model) to learn behavior of the storage system (as will be described elsewhere below).

Using feature vectors in the voting window to infer the ransomware activity, in some approaches, includes causing (polling) one or more AI engines that analyze the feature vectors in the voting window and cast a vote as to whether the information of the feature vectors of the voting window are based on operations performed within the storage system that are ransomware activity. Accordingly, using feature vectors in the voting window to infer the ransomware activity may include determining whether a majority of inferred votes on the feature vectors in the voting window exceed a dynamically adjustable threshold. In response to a determination that the majority of the inferred votes on the feature vectors in the voting window exceed the dynamically adjustable threshold, a determination is preferably made that the storage system is targeted by and/or being actively attached by a ransomware attack.

In some preferred approaches, one or more AI engines that process the feature vectors of the voting window to cast a vote as to whether the storage system is targeted by and/or being actively attached by a ransomware attack may base their vote on whether the feature vectors demonstrate I/O activity associated with one or more of the volumes of the storage system exceeding a historical average of I/O activity by more than a predetermined multiplier (e.g., 2×, 4×, 10×, etc.).

Operation 222 includes determining a response for mitigating a ransomware attack associated with the ransomware activity. Determining a response for mitigating the ransomware attack associated with the ransomware activity, in some approaches, includes causing one or more AI engines to identify vulnerabilities within the storage system, e.g., storage device(s) that host volumes associated with the feature vectors of the voting window. The storage system may be caused to send an alert to a management system, in some preferred approaches, as a response. Typically, in some approaches, taking the storage device offline as a response to a detection of a potential ransomware activity is not preferred. However, some responses may include taking the storage device offline, in some approaches. The storage device(s) may be, at least temporarily, taken offline to prevent current unauthorized access events from leading to an initiated ransomware attack. The response may additionally and/or alternatively include initiating a re-authentication policy to any user device currently accessing data of the storage system, where the re-authentication policy heightens thresholds and/or login requirements that the user devices need to re-authenticate. Other ransomware attack responses of a type that would become apparent to one of ordinary skill in the art after reading the descriptions herein may additionally and/or alternatively be used.

Operation 224 includes causing the response to be performed. In some approaches, causing the response to be performed includes instructing a controller of the storage system to perform the determined response.

In some approaches, the operations of method 200 may be performed by an AI model that is trained using a predetermined training set of data. More specifically, operations of method 200 may additionally and/or alternatively include training an AI engine to use training feature vectors in a training voting window to infer simulated ransomware activity. For example, in some approaches, various of the operations noted above may be deployed in a trained state of a trained AI model. In some approaches, the training feature vectors are of a size of a training set of data that would become apparent to one of ordinary skill in the art after reading the descriptions herein. An accuracy of the AI engine may be determined before the AI engine is deployed to perform the operations described herein, e.g., see operations of method 200. Initial training may include reward feedback that may, in some approaches, be implemented using a subject matter expert (SME) that generally understands whether a vote is cast accurately or not (based on having access to historical records that the training feature vectors are based on). However, to prevent costs associated with relying on manual actions of a SME, in another approach, reward feedback may be implemented using techniques for training a large language model (LLM) for time series BERT model, as would become apparent to one skilled in the art after reading the present disclosure.

Once a determination is made that the AI model achieves a redeemed threshold of accuracy of performing the operations described herein during this training, a decision that the model is trained and ready to deploy for performing techniques and/or operations of method 200 may be performed. For example, in response to a determination that the AI engine exceeds a predetermined threshold of accuracy, the AI engine is caused to use the feature vectors in the voting window to infer the ransomware activity and caused to determine the response for mitigating the ransomware attack associated with the ransomware activity.

In some further approaches, the AI model may be a neuromyotonic AI model that may improve performance of computer devices in an infrastructure associated with the storage system, because the neuromyotonic AI model may not need an SME and/or iteratively applied training with reward feedback in order to accurately perform operations described herein. Instead, the neuromyotonic AI model is configured to make determinations described in operations herein. Weight values may, in some approaches, be used by the AI reasoning model to collect and analyze information and/or feedback potentially received from customer devices and/or an administrator device that is used to manage the storage system. Such an AI model ensures that ransomware attacks are identified and mitigated, where the scale of such analysis and determinations would not otherwise be feasible for a human to perform. This is because humans are not able to efficiently identify and mitigate ransomware attacks in storage systems and would otherwise incorporate processing delays and errors in the process of attempting to identify such attacks. In other words, no human is able to identify ransomware attacks as they are electronically initiated in a faster period of time than humans can process I/O data (a ransomware attack will be successfully completed far before a human is able to even aggregate relevant I/O data). This is even more true when ransomware detection is performed on a large number of volumes, e.g. hundreds or thousands of volumes concurrently in a storage system. Accordingly, management of operations described herein is not able to be achieved by human manual actions.

Because ransomware attacks are associated with compromised performance of computer device within the technical field of storage systems, the techniques described herein improve the function of computer device within the technical field of storage systems (by identifying and mitigating such attacks). This is because ransomware attacks are specifically designed to disrupt intended and normal operations of these computer devices in order to extort rewards from victims of the ransomware attacks. This compromised performance occurs for at least the period that the ransomware attack disrupts processing operations of the computer device. By using the techniques described herein to mitigate these attacks, the techniques described herein preserve performance of the storage system that these computer device operates within. Accordingly, these techniques are a solution to the longstanding and unmet need for solutions to efficiently mitigate ransomware attacks within the technical field of data storage systems.

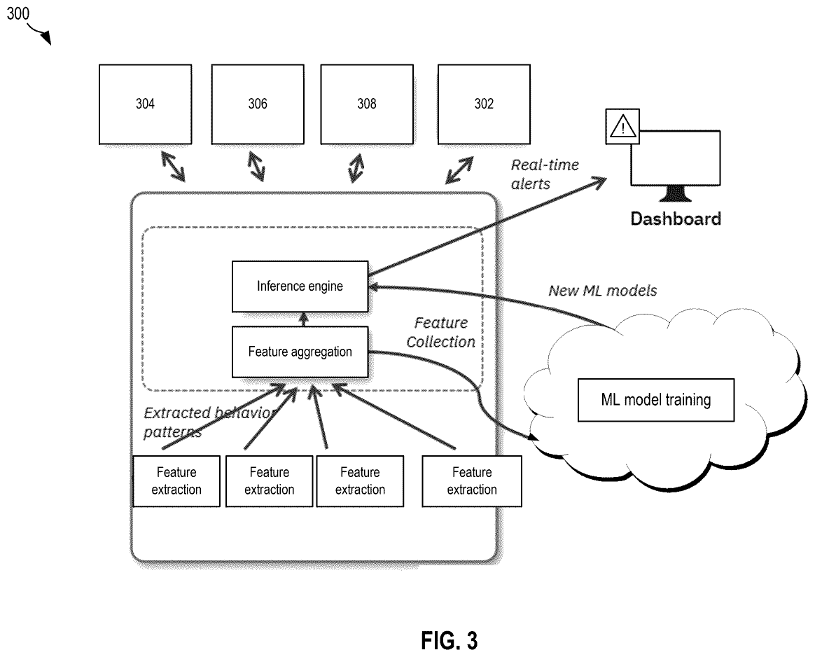

FIG. 3 depicts a storage system infrastructure 300, in accordance with one embodiment. As an option, the present storage system infrastructure 300 may be implemented in conjunction with features from any other embodiment listed herein, such as those described with reference to the other FIGS. Of course, however, such storage system infrastructure 300 and others presented herein may be used in various applications and/or in permutations which may or may not be specifically described in the illustrative embodiments listed herein. Further, the storage system infrastructure 300 presented herein may be used in any desired environment.

The storage system infrastructure includes computational storage devices, e.g., see inference engine and feature aggregation, which collect features from I/O operations performed on data storage system components, e.g., see feature extraction. More specifically, the feature aggregator collects and aggregates feature information. These I/O operations, in some approaches, involve operations performed with other infrastructure 302 in a cloud network, e.g., devices 302-308. These collected features are arranged as vectors and are added in windows based on whether or not write operations were performed at the time the feature information was collected. A trained machine learning model (an AI engine) is used in the process of detecting anomalous behavior, which may then be used to output alerts, e.g., see real time alerts output to the dashboard. Mitigation of a detected ransomware attack is also enabled using techniques described elsewhere herein.

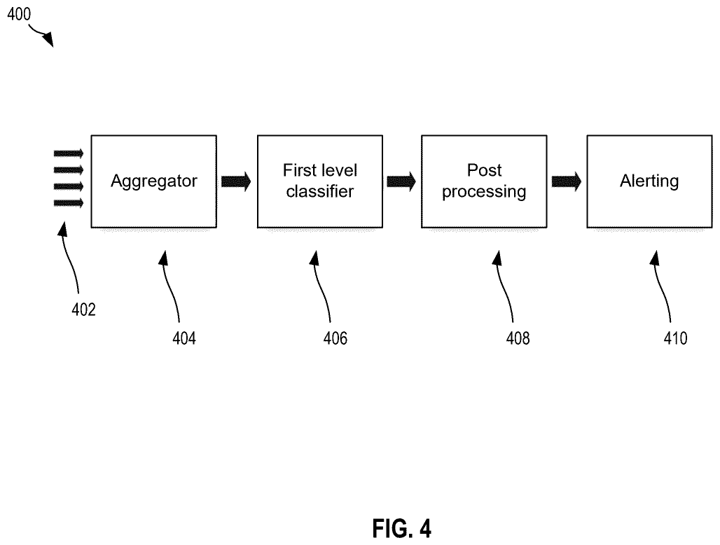

Now referring to FIG. 4, a flowchart of a method 400 is shown according to one embodiment. The method 400 may be performed in accordance with aspects of the present invention in any of the environments depicted in FIGS. 1-6C, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

Operation 402 includes obtaining new feature vectors from the computational storage devices which are then aggregated by an aggregator component in operation 404 and classified in operation 406 by a first level classifier to determine information about the feature vectors, e.g., such as whether the feature vectors are based on I/O operations performed while write operations occurred.

Two separate windows are used for post-processing, e.g., see operation 408. In some approaches, an outer window records feature vectors from all epochs while an inner window, also called a voting window, only holds epochs with write activity. Hence, in one or more of such approaches, epochs with no writes are dropped (not added to the voting window). When a feature vector of an epoch is removed from the outer window, it is also removed from the voting window. By doing this, the voting window is caused to have a longer time history up to the length of epochs in the outer window which is fixed. In some preferred approaches, the outer window is about three times the size of the voting window size. In one embodiment, majority voting is performed on the number of samples in the voting window. From an implementation perspective, in some approaches, this voting may be implemented using a simple bagging approach. In a similar manner as skipping epochs with no writes, other characteristics (e.g., low entropy, high compressibility, . . . ) may, in some approaches, additionally be used in parallel and/or alternatively used with separate outer and inner windows. The feature vectors of these windows (and specifically those in the voting window) are preferably used to infer ransomware activity, and actions may be performed to prevent ransomware attacks from occurring, e.g., see altering performed in operation 410.

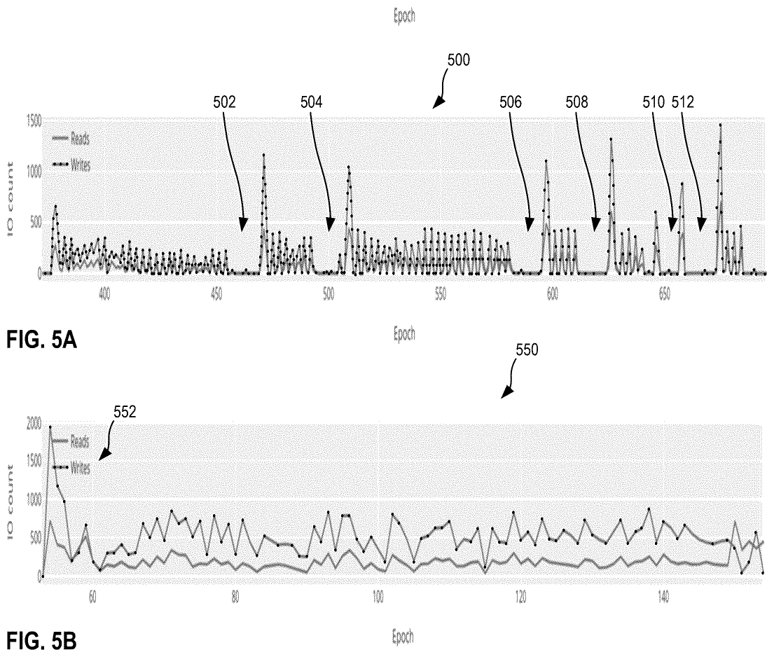

FIGS. 5A-5B depict plots 500 and 550 that illustrate the I/O behavior of various ransomware samples, in accordance with several embodiments. As an option, the present plots 500 and 550 may be implemented in conjunction with features from any other embodiment listed herein, such as those described with reference to the other FIGS. Of course, however, such plots 500 and 550 and others presented herein may be used in various applications and/or in permutations which may or may not be specifically described in the illustrative embodiments listed herein. Further, the plots 500 and 550 presented herein may be used in any desired environment.

Referring first to FIG. 5A, plot 500 illustrates the I/O behavior of a first ransomware sample. Specifically, the plot 500 illustrates epochs versus I/O counts with respect to read and write operations performed in a storage system. Various portions of the data show a pause in read and write operations, e.g., see portions 502-512. Feature vectors based on these portions of data are preferably excluded from the voting windows described herein to ensure a reduction in processing workload of a computer device hosting an AI model to perform the techniques described herein.

Referring now to FIG. 5B, plot 550 illustrates the I/O behavior of a second ransomware sample. Specifically, the plot 500 illustrates epochs versus I/O counts with respect to read and write operations performed in a storage system. Abnormally high write operations, e.g., see portion 552, being performed within storage system may be identified and used to infer ransomware activity, in some approaches.

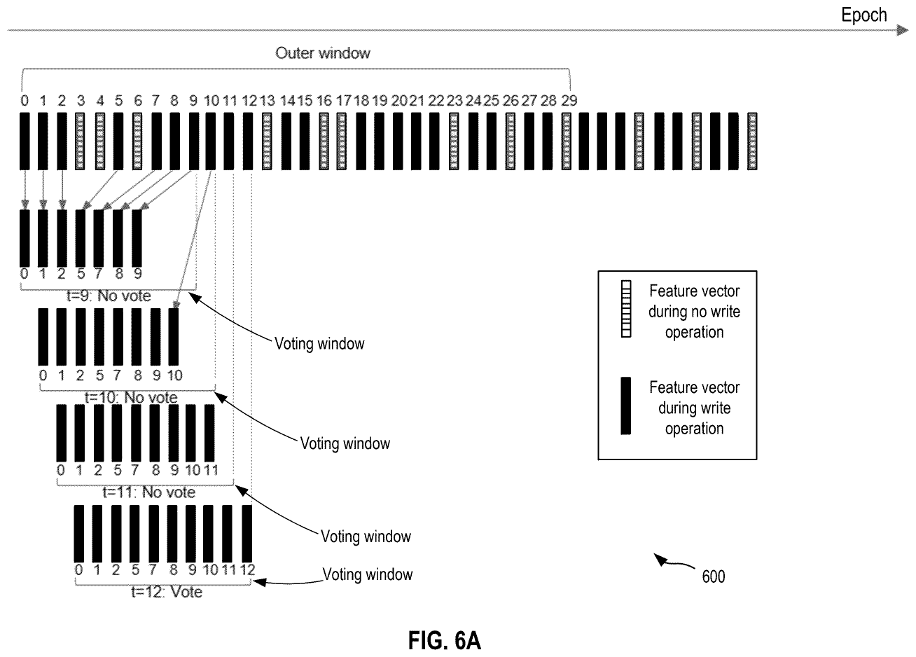

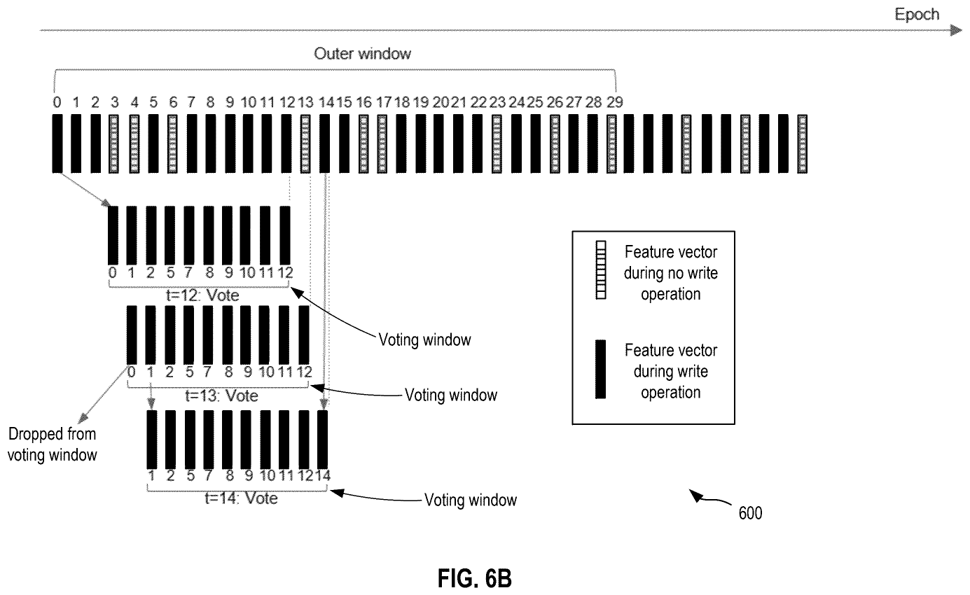

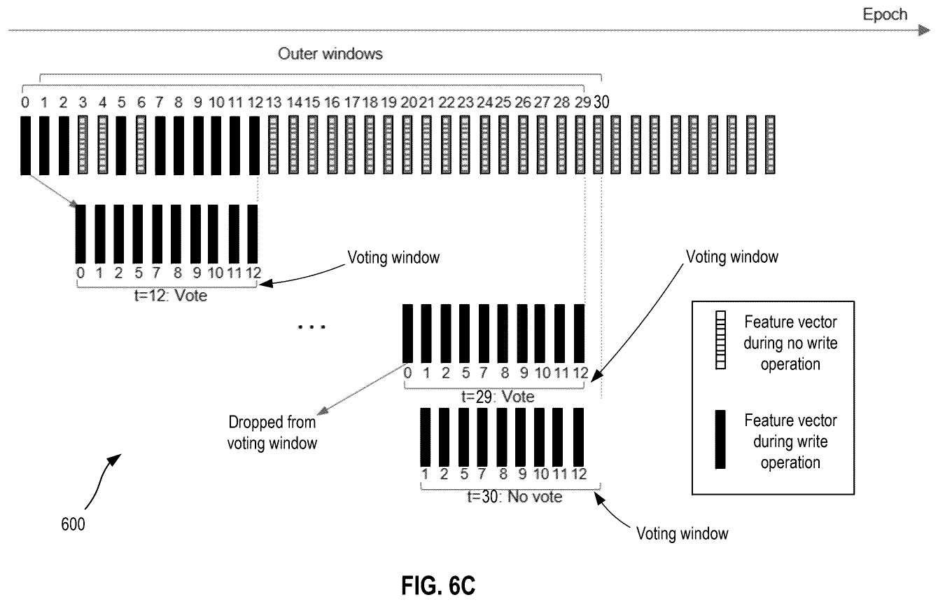

FIGS. 6A-6C depict a time progression 600, in accordance with several embodiments. As an option, the present time progression 600 may be implemented in conjunction with features from any other embodiment listed herein, such as those described with reference to the other FIGS. Of course, however, such time progression 600 and others presented herein may be used in various applications and/or in permutations which may or may not be specifically described in the illustrative embodiments listed herein. Further, the time progression 600 presented herein may be used in any desired environment.

Referring first to FIG. 6A, over the time progression 600, as feature vectors are received, the feature vectors are added to an outer window, e.g., see Outer window which has a size of thirty time samples. Furthermore, in response to a determination that write operations are detected in a period covering the feature vectors added to the outer window, these feature vectors (that occurred during the write operations) are also added into a voting window, e.g., see voting window which is progressively filled from time sample t=9 to t=12. The feature vectors in the voting window are used to infer ransomware activity. For example, a vote is performed at time sample t=12 to determine whether at least a majority of a plurality of trained AI engines infer ransomware activity exists in a storage system that the feature vectors are based on. Meanwhile, an epoch with no voting means no ransomware activity is detected after an analysis of the feature vectors of the voting window. In embodiments where the feature information of the feature vectors is not needed to perform the voting, the detected label or the probability of the detected label may be placed into the windows instead of storing entire feature vectors.

Referring now to FIG. 6B, over the time progression 600, the relatively oldest feature vectors present in the voting window are removing to make room for relatively newer feature vectors present in the outer window, e.g., see feature vector 0 dropped from the voting window at time sample t=13 while feature vector 14 is then added (as a replacement) to the voting window at time sample t=14.

Referring now to FIG. 6C, over the time progression 600, in response to a determination that the outer window is full, a relatively oldest feature vector is removed from the outer window, e.g., see feature vector 0 dropped from the outer window as feature vector 30 is added. In response to the determination that the outer window is full, a determination may be made as to whether the relatively oldest feature vector (that was removed from the outer window) is present in the voting window. In response to a determination that the relatively oldest feature vector is present in the voting window, the relatively oldest feature vector may also be removed from the voting window, e.g., see feature vector 0 removed from the voting window at time sample t=30. Note that feature vector being added to the outer window at time t=30 has no write operations and is therefore not added to the inner window, Further, in some embodiments, majority voting may be skipped at t=30 as the inner window is no longer fully filled (as illustrated in FIG. 6C) or in other embodiments performed with the remaining feature vectors.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
adding an incoming first feature vector to an outer window;
in response to a determination that the first feature vector is a qualifying feature vector, adding the first feature vector into a voting window;
in response to a determination that the outer window is full, removing a relatively oldest feature vector from the outer window; and
using feature vectors in the voting window to infer ransomware activity.

2. The method of claim 1, further comprising:
in response to the determination that the outer window is full, determining whether the relatively oldest feature vector is present in the voting window; and
in response to a determination that the relatively oldest feature vector is present in the voting window, removing the relatively oldest feature vector from the voting window.

3. The method of claim 1, wherein the relatively oldest feature vector is a second feature vector.

4. The method of claim 1, wherein the first feature vector details feature information about operations performed within a storage system.

5. The method of claim 4, wherein the feature information is selected from the group consisting of: read transfer size, write transfer size, an entropy of writes, an application tag, a logical block address (LBA) of a write operation, and an LBA of a read operation.

6. The method of claim 4, further comprising:
determining a response for mitigating a ransomware attack associated with the ransomware activity; and
causing the response to be performed.

7. The method of claim 6, wherein the using feature vectors in the voting window to infer the ransomware activity comprises:
determining whether a majority of inferred votes on the feature vectors in the voting window exceed a dynamically adjustable threshold; and
in response to a determination that the majority of the inferred votes on the feature vectors in the voting window exceed the dynamically adjustable threshold, determining that the storage system is targeted by a ransomware attack.

8. The method of claim 6, further comprising:
training an artificial intelligence (AI) engine to use training feature vectors in a training voting window to infer simulated ransomware activity;
determining an accuracy of the AI engine; and
in response to a determination that the AI engine exceeds a predetermined threshold of accuracy, causing the AI engine to use the feature vectors in the voting window to infer the ransomware activity and determine the response for mitigating the ransomware attack associated with the ransomware activity.

9. The method of claim 1, further comprising:
determining whether the first feature vector is a qualifying feature vector,
wherein the first feature vector is determined to be a qualifying feature vector in response to a determination that write operations are detected in a period covering the first feature vector.

10. A computer program product comprising:
one or more computer-readable storage media; and
program instructions stored on the one or more storage media to perform operations comprising:
adding an incoming first feature vector to an outer window;
in response to a determination that the first feature vector is a qualifying feature vector, adding the first feature vector into a voting window;
in response to a determination that the outer window is full, removing a relatively oldest feature vector from the outer window; and
using feature vectors in the voting window to infer ransomware activity.

11. The computer program product of claim 10, wherein the operations further comprise:
in response to the determination that the outer window is full, determining whether the relatively oldest feature vector is present in the voting window; and
in response to a determination that the relatively oldest feature vector is present in the voting window, removing the relatively oldest feature vector from the voting window.

12. The computer program product of claim 10, wherein the relatively oldest feature vector is a second feature vector.

13. The computer program product of claim 10, wherein the first feature vector details feature information about operations performed within a storage system.

14. The computer program product of claim 13, wherein the feature information is selected from the group consisting of: read transfer size, write transfer size, an entropy of writes, an application tag, a logical block address (LBA) of a write operation, and an LBA of a read operation.

15. The computer program product of claim 13, wherein the operations further comprise:
determining a response for mitigating a ransomware attack associated with the ransomware activity; and
causing the response to be performed.

16. The computer program product of claim 15, wherein the using feature vectors in the voting window to infer the ransomware activity comprises:
determining whether a majority of inferred votes on the feature vectors in the voting window exceed a dynamically adjustable threshold; and
in response to a determination that the majority of the inferred votes on the feature vectors in the voting window exceed the dynamically adjustable threshold, determining that the storage system is targeted by a ransomware attack.

17. The computer program product of claim 15, wherein the operations further comprise:
training an artificial intelligence (AI) engine to use training feature vectors in a training voting window to infer simulated ransomware activity;
determining an accuracy of the AI engine; and
in response to a determination that the AI engine exceeds a predetermined threshold of accuracy, causing the AI engine to use the feature vectors in the voting window to infer the ransomware activity and determine the response for mitigating the ransomware attack associated with the ransomware activity.

18. The computer program product of claim 15, wherein the operations further comprise:
determining whether the first feature vector is a qualifying feature vector,
wherein the first feature vector is determined to be a qualifying feature vector in response to a determination that write operations are detected in a period covering the first feature vector.

19. A computer system comprising:
a processor set;
one or more computer-readable storage media; and
program instructions stored on the one or more storage media to cause the processor set to perform operations comprising:
adding an incoming first feature vector to an outer window;
in response to a determination that the first feature vector is a qualifying feature vector, adding the first feature vector into a voting window;
in response to a determination that the outer window is full, removing a relatively oldest feature vector from the outer window; and
using feature vectors in the voting window to infer ransomware activity.

20. The computer system of claim 19, wherein the operations further comprise:
in response to the determination that the outer window is full, determining whether the relatively oldest feature vector is present in the voting window; and
in response to a determination that the relatively oldest feature vector is present in the voting window, removing the relatively oldest feature vector from the voting window.
